(19) United States
(12) Patent Application Publication
(10) Pub. No.: US 2022/0375017 A1
(43) Pub. Date: Nov. 24, 2022

(54) SYSTEM AND METHOD FOR INTEGRATING AN ONLINE PLATFORM WITH COMPUTING SYSTEM INFRASTRUCTURES OF EDUCATIONAL INSTITUTIONS

(71) Applicants: Unmudl Public Benefit Corp., Sussex, DE (US); Pragya Systems, Corp., Cambridge, MA (US)

(72) Inventors: Merrilea Mayo, North Potomac, MD (US); Asad Raza, Lakeway, TX (US); Parminder Jassal, Lakeway, TX (US); Ajay Sharda, Acton, MA (US); Ramji Raghavan, Winchester, MA (US); Deepak Lalwani, Cambridge, MA (US)

(21) Appl. No.: 17/715,157

(22) Filed: Apr. 7, 2022

Related U.S. Application Data
(60) Provisional application No. 63/173,692, filed on Apr. 12, 2021.

(51) Int. Cl. G06Q 50/20; G06Q 30/06; G06Q 10/10; G06Q 10/02

(52) U.S. Cl. CPC G06Q 50/2057; G06Q 30/0635; G06Q 10/1053; G06Q 10/025

(57) ABSTRACT

A system for connecting technological infrastructure of educational institutions with an external web-based marketplace platform, the system comprising an infrastructure coupler that integrates data between institutional information systems and a marketplace system. The infrastructure coupler retrieves course data from the institutional information systems and provides the marketplace system with access to the retrieved course data. The marketplace platform uses the infrastructure coupler to access the course data associated with the learning courses, generate offerings for the learning courses based on the course data, and process enrollments and payments to the learning courses. The system further comprising an end-user portal including access to content associated with the learning courses from a learning management system at the institutional information systems and an employer portal configured to solicit talent from a pool of users corresponding to the learning courses, as well as communicate specific requests to institutional officials.

### CROSS REFERENCE TO RELATED APPLICATION

This application claims the priority of U.S. Provisional Application No. 63/173,692, entitled “SYSTEM AND METHOD FOR INTEGRATING AN ONLINE PLATFORM WITH COMPUTING SYSTEM INFRASTRUCTURES OF EDUCATIONAL INSTITUTIONS,” filed on Apr. 12, 2021, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to providing online educational courses, and in particular, connecting employers with educational institution systems to facilitate an exchange of data about courses and jobs.

### Description of the Related Art

Existing job posting websites allow potential employees to search through job postings electronically posted at the websites and to respond to desired job postings by electronically submitting credentials and a resume to companies of the job listings. A particular drawback of these websites is that they do not adequately screen candidates prior to submitting credentials of the candidates to the posting companies. As a result, less-than-desirable candidates may be able to respond to job postings, which results in a waste of the posting company's time and resources.

Employers often know what skill sets they need to hire and could easily get access to those with the right training well ahead of their competitors, if they could contact students while they are still taking a relevant class that teaches those skill sets. By contacting students in a class who are learning or have learned a specific skill, employers may cut down on spurious applications to a given job opening. This way, employers are certain that each person who responds to the employers, has had, or is in the process of obtaining, skill sets desired by the employers. However, there are roadblocks in knowing who to contact or how to get in contact with such students. Each educational institution has its own unique bureaucracy which takes a substantial amount of time to learn to navigate. Because it may take a substantial amount of time to figure this out, most employers do not pursue this avenue for seeking potential employees.

Employers often seek talent for hands-on skills needed for high paying middle-skills jobs, such as welding, HVAC, electrical repair, etc. Students gaining this kind of practical experience are nearly impossible to reach, because the corresponding hands-on course currently has no online-discoverable outlet.

Additionally, students may stand to benefit from obtaining information and feedback from employers on which courses are beneficial or critical to take depending on their anticipated career path. Students often do not give enough consideration the importance of certain courses to take until they are out in the job market.

There is thus a need for a system that helps connect students who are qualified by skills they learn from taking certain courses with potential employers who are seeking to hire those with such skills.

### SUMMARY OF THE INVENTION

The present invention provides a method and system for connecting technological infrastructure of educational institutions with an external web-based platform. The disclosed system may comprise a decentralized architecture including a multi-institution course marketplace system that handles both in-person and online courses where the course content is not centralized and not necessarily virtual. The marketplace system may facilitate and communicate electronic messages and data for enrollment of the courses between students, educational institutions, and employers.

According to one embodiment, the system comprises a system infrastructure coupler that integrates data between institutional information systems and a marketplace system, wherein the system infrastructure coupler retrieves course data from the institutional information systems and provides the marketplace system with access to the retrieved course data. The institutional information systems may also provide the marketplace system with up-to-date enrollment data (seats available to sell), based on a combination of native (to the institution) and marketplace system-processed students. Student-specific data, such as student ID, course progress and course completion data are also transmitted from the institutional information systems to the marketplace system, to populate private student records inside an end-user portal of the marketplace system.

The marketplace system comprises a web-based platform managing learning courses associated with the institutional information systems, wherein the marketplace system uses the system infrastructure coupler to access the course data associated with the learning courses, generate offerings for the learning courses based on the course data, and process enrollments to the learning courses with the institutional information systems using student information. The system further comprises an end-user portal communicatively coupled to the marketplace system, wherein the end-user portal includes access to content associated with the learning courses by accessing a learning management system hosted within an institution's information systems via authentication by the system infrastructure coupler. The end-user portal is configured to receive the student information from an end-user client device and transmit the student information to the marketplace system.

The system may further comprise the marketplace system configured to access the course data from the system infrastructure coupler by using a common set of application programming interfaces. In an alternative embodiment, marketplace system may directly communicate with institutional information system(s) using either a specific API or a common set of APIs. The marketplace system may also be configured to access the course data from the system infrastructure coupler by using an automated flat file upload and download configuration. The learning courses may include in-person, online, and hybrid learning courses. The system infrastructure coupler may be configured to firewall individual ones of the institutional information systems.

The system may further comprise an institution portal configured to add and publish the learning courses to the marketplace system. The system may further comprise an employer portal configured to solicit talent from a pool of users corresponding to the learning courses. In another embodiment, the system may further comprise an employer portal configured to direct requests to educational institutions associated with the institutional information systems. The requests may include at least one of reserving a campus facility or meeting space, reserving equipment time, requesting a speaker, requesting a consultant, requesting an employee, commissioning a new course, requesting a custom course (e.g., request for proposal), requesting a coupon/gift codes for a course, coordinating tuition reimbursement programs, identifying top students in a course, inquiring about a credential, collaborating on a physical event, hosting a job fair or other career service, collaborating on an initiative, coordinating an internship/externship program, and conducting new employee skills assessments. The system may also comprise an employer portal configured to connect with users that have taken the learning courses. In yet another embodiment, the system may further comprise an employer portal configured to connect with instructors of the learning courses.

The end-user portal may be configured to identify employers hiring out of certain ones of the learning courses. The end-user portal may also be configured to retrieve profiles of employers hiring out of certain ones of the learning courses. The end-user portal may be configured to generate a course-specific user career pathway. The course-specific user career pathway may include potential credentials, degrees, or job opportunities that a given one of the learning courses lead to. The system may further comprise an administrative portal including dashboard analytics, end-user management, course management, blog management, promotional codes, and messaging with institutions, employers, and end-users. According to another embodiment, the system may further comprise a white-label course listing module configured to filter the course data from the marketplace system for course offerings from a specific educational institution or employer and export the filtered course data to custom-branded white-label web pages integrated with a website corresponding to the specific educational institution or employer.

According to one embodiment, the method comprises receiving course data in response to a request from an institution client device to publish a course on a web-based platform, publishing a course offering based on the course data, determining purchase of the course offering, generating a notification to an institutional information system associated with the course offering, and integrating access to a learning management system associated with the institutional information system with the web-based platform. A series of notifications may be sent to personnel at the educational institutions to allow the educational institutions the ability to respond to student enrollments with electronic communications including where and when the student should be present.

The access may include downloadable or streamable content from the learning management system. The downloadable or streamable content may include lecture videos, conference links/information, documents, and exams. The method may further comprise identifying employer requests in association with a course corresponding to the course offering and indicating in the course offering that employers associated with the employer requests are interested in students who take a course corresponding to the course offering. A student's progress through a course may be tracked through the learning management system in an account on the end-user portal.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates another computing system according to an embodiment of the present invention.

FIG. 3 illustrates an exemplary interface for assigning expertise levels to a course according to an embodiment of the present invention.

FIG. 4 illustrates an exemplary end-user portal according to an embodiment of the present invention.

FIGS. 5A and 5B illustrate exemplary pathway depictions for a course offering according to an embodiment of the present invention.

FIG. 6 illustrates an exemplary detailed view of a given pathway according to an embodiment of the present invention.

FIG. 7 illustrates an exemplary employer indication for a given course listing according to an embodiment of the present invention.

FIG. 8 illustrates an exemplary employer hiring page according to an embodiment of the present invention.

FIG. 9 illustrates an exemplary checkout interface according to an embodiment of the present invention.

FIG. 10 illustrates an exemplary course gifting interface according to an embodiment of the present invention.

FIG. 11 illustrates an exemplary course gift message according to an embodiment of the present invention.

FIGS. 12 and 13 illustrate an exemplary employer request messaging interface according to an embodiment of the present invention.

FIG. 14 illustrates an exemplary interface for course-level messaging according to an embodiment of the present invention

FIG. 15 illustrates a flowchart of a method for connecting technological infrastructure of educational institutions with an external web-based platform according to an embodiment of the present invention.

FIG. 16 illustrates a flowchart of a method for publishing courses according to an embodiment of the present invention.

FIG. 17 illustrates a flowchart of a method for processing course enrollment according to an embodiment of the present invention.

FIG. 18 illustrates a flowchart of a method for facilitating source talent requests according to an embodiment of the present invention.

FIG. 19 illustrates a flowchart of a method for facilitating employer to institution services requests according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present application discloses a system and method for connecting technological infrastructure of educational institutions (e.g., colleges, training centers, vocational schools, etc) with an external web-based platform to connect employers with educational institution systems to facilitate the exchange of data about courses and jobs. Employers, as discussed herein, may include employment intermediary organizations, such as workforce boards, chambers of commerce, staffing agencies, youth services organizations, trade union, job placement non-profit organizations, etc. The disclosed system may access an educational institution's existing registration, enrollment, and course delivery systems to provide a number of functions including letting employers rate classes on how useful they are to particular professions so students can use that to decide whether to take them and to post job listings with students in the class. The disclosed system may comprise a decentralized architecture including a multi-institution course marketplace system that handles both in-person and online courses where the course content is not centralized and not necessarily virtual. The marketplace system may facilitate and communicate electronic messages and data for enrollment of the courses between students and educational institutions.

The disclosed system may include an end-user portal, where users can buy courses offered either virtually or on-location at educational institutions, send and receive messages from educational institutions (e.g., questions, course information), and perform other functions. The disclosed system may include an educational institution portal, where educational institution administrators can post courses and manage student enrollments and refunds. The disclosed system may include an employer portal, where employers can send messages to students in, or instructors of, a particular class as well as send messages to educational institution administrators covering a specific function (e.g., meeting space rental). The disclosed system may also include an overall administrative portal, which allows an administrator to manage the end-user, educational institution, and employer portals.

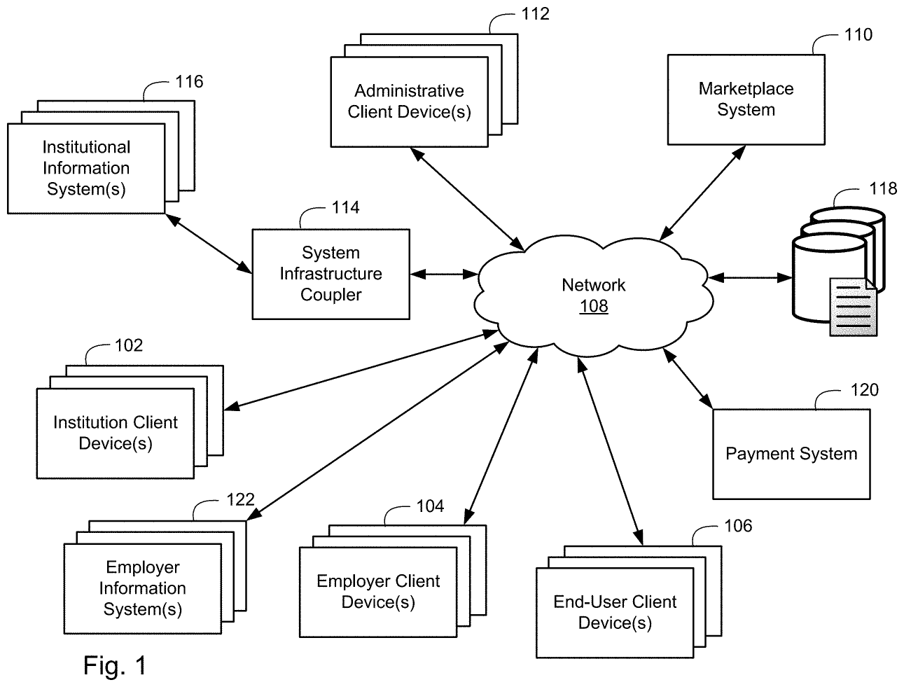

FIG. 1 presents a computing system according to an embodiment of the present invention. The system presented in FIG. 1 includes institution client device(s) 102, employer client device(s) 104, end-user client device(s) 106, network 108, marketplace system 110, administrative client device(s) 112, system infrastructure coupler 114, institutional information system(s) 116, database(s) 118, and payment system 120. Client devices 102, 104, 106, and 112 comprise computing devices, such as desktop computers, television devices, terminals, laptops, personal digital assistants (PDA), cellular phones, smartphones, tablet computers, e-book readers, smart watches and smart wearable devices, or any computing device having a central processing unit and memory unit capable of connecting to a network). Client devices 102, 104, 106, and 112 may also comprise a graphical user interface (GUI) or a browser application provided on a display (e.g., monitor screen, LCD or LED display, projector, etc.).

The client devices 102, 104, 106, and 112 may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. According to at least another embodiment, the client devices 102, 104, 106, and 112 may comprise virtual reality and augmented reality devices that may be used to provide data input or to engage with/consume content, such as courses. Client devices 102 may also include or execute an application to communicate content, such as, for example, textual content, multimedia content, or the like. The client devices 102, 104, 106, and 112 may also include or execute an application to perform a variety of possible tasks, such as browsing, searching, playing various forms of content, including locally stored or streamed video or games.

Client devices 102, 104, 106, and 112 may include or execute a variety of operating systems, including a personal computer operating system, such as a Windows, Mac OS or Linux, or a mobile operating system, such as iOS, Android, or Windows Phone, or the like. The client devices 102 may include or may execute a variety of possible applications, such as a client software application enabling communication with other devices, such as communicating one or more messages, such as via email, short message service (SMS), multimedia message service (MMS), or messages on social network platforms including, for example, Facebook, LinkedIn, Twitter, Pinterest, Snapchat, or Instagram, to provide only a few possible examples.

Institutional information system(s) 116 include systems or servers of a plurality of separate educational institutions for functions, such as course information, registration (e.g., creation of a new student with a new student ID), enrollment, student identification/authentication (e.g., allowing login to the institutional information system(s) 116), maintaining academic records (such as courses completed, degrees conferred, etc.), and course delivery. Educational institutions have typically invested many dollars and a great deal of information technology staff time getting such institutional information system(s) 116 set up to work properly. The disclosed system can accommodate the institutional information system(s) 116 via system infrastructure coupler 114, rather than requiring educational institutions to develop or maintain new systems. System infrastructure coupler 114 may comprise an application or cloud computing/virtualized instance that integrates data (e.g., course data, enrollment, and registration) between educational institutions via institutional information system(s) 116 and a marketplace system 110.

An application programming interface (“API”) may be used by system infrastructure coupler 114 to retrieve and transmit data to institutional information system(s) 116. Requests by system infrastructure coupler 114 to access information housed in institutional information system(s) 116 may be authenticated by an API key or a token in an API request. Alternatively, the authentication may take place externally via a third party identity and access management system that is situated in between institutional information system(s) 116 and system infrastructure coupler 114. System infrastructure coupler 114 may firewall each of institutional information system(s) 116 from the others. Marketplace system 110 can then access and exchange data resident in the system infrastructure coupler 114 via a common set of APIs that work regardless of educational institution (or institutional information system(s) 116). The system infrastructure coupler 114 may be configured to handle authentication, authorization, enrollment, single sign-on and data transfer between marketplace system 110 and, for example, an educational institution's learning management system (“LMS”), student information system (“SIS”), course information system (“CIS”), and identity providers (“IdPs”). The system infrastructure coupler 114 may also extract course descriptive data or degree pathways information from institutional information system(s) 116.

In an alternative embodiment, marketplace system 110 may directly communicate with institutional information system(s) 116 using either a specific API or a common set of APIs. According to another embodiment, if the institutional information system(s) 116 does not have API capability, an automated file (e.g., comma-separated values (“CSV”) flat file, tab-deliminated text file, or any other file compatible with spreadsheet programs) upload/download may be configured on a fixed schedule or via manual trigger to accomplish the same functionality as an API, though asynchronously. This configuration may be used for connecting older institutional information system(s) 116 to the system infrastructure coupler 114 and hence to marketplace system 110.

Marketplace system 110 may comprise one or more servers or cloud computing instances configured as a web-based platform for managing (including the sale and enrollment of) in-person, online, or hybrid (e.g., in-person and online) learning courses that are offered by a plurality of educational institutions. Many educational institutions have a substantial catalog of in-person courses that cannot be passed on to traditional online course aggregators. Many skills necessary for high paying middle-skills jobs, such as welding, nursing, HVAC (heating, ventilation, and air conditioning), electrical repair, etc., require hands-on practice that cannot be delivered in an exclusively online course format. However, with the ability to offer in-person, online, or hybrid courses, an educational institution's entire catalog of courses may be uploaded to marketplace system 110 according to embodiments of the present invention.

The marketplace system 110 may use system infrastructure coupler 114 to retrieve courses data from institutional information system(s) 116 and provide course offerings on a website based on the courses data to end-user client device(s) 106. Institutional information system(s) 116 may provide the marketplace system 110 with up-to-date enrollment data (seats available to sell), based on a combination of native (to the institution) and marketplace system-processed students. Marketplace system 110 may include advertising tools for selling courses to users of end-user client device(s) 106. The marketplace system 110 may further create a listing of course offers based on information from system infrastructure coupler 114 and/or institution client device(s) 102 and generate recommendations, discounts, and promotions to end-user client device(s) 106. Marketplace system 110 may be integrated with functionality of institutional information system(s) 116 and, for example, create a front end for end-user client device(s) 106 to enroll and register with institutional information system(s) 116.

Marketplace system 110 may generate portals accessible by institution client device(s) 102, employer client device(s) 104, end-user client device(s) 106, and administrative client device(s) 112. To access the portals, users of institution client device(s) 102, employer client device(s) 104, and end-user client device(s) 106 may create and login to accounts that are stored on database(s) 118 (e.g., individual databases by user type (educational institutions, employers, and end-users), or by educational institution or employer). Database(s) 118 may comprise physical and/or cloud storage on platforms, such as Amazon Web Services Storage and MongoDB. Accounts may include information, such as full name, email address, social networking profile links, profile photograph, phone number, address, and payment information. Institution client device(s) 102 connects to marketplace system 110 through network 108 and may perform functions through an institution portal, such as managing courses data and student enrollment data via access to data previously supplied by institutional information system(s) 116 through system infrastructure coupler 114, or data previously supplied from institution client device(s) 102 and stored to database(s) 118 via network 108.

Employer client device(s) 104 connects to marketplace system 110 through network 108 and may utilize educational institution services through an employer portal provided by marketplace system 110 to source talent from a pool of users of the end-user client device(s) 106 corresponding to the courses data and/or course offerings based on the courses data. Employer client device(s) 104 may also use the employer portal to direct requests, through marketplace system 110, to any given one of educational institutions associated with the institutional information system(s) 116. The requests may include reserving a campus facility or meeting space, reserving equipment time, requesting a speaker, requesting a consultant, requesting an employee, commissioning a new course, requesting a custom course (e.g., request for proposal), requesting a coupon/gift codes for a course, coordinating tuition reimbursement programs, identifying top students in a course, inquiring about a credential, collaborating on a physical event, hosting a job fair or other career service, collaborating on an initiative, coordinating an internship/externship program, and requesting services, such as conducting new employee skills assessments, setting up a demonstration or lab. Marketplace system 110 may provide course level messaging to connect the employer client device(s) 104 to users of end-user client device(s) 106 who have taken or are taking a specific course. The employer client device(s) 104 may further communicate with course instructors/educational institution administrators (or users of institution client device(s) 102) for talent in a specific course offered by an educational institution. The employer client device(s) 104 may also add and publish courses to marketplace system 110 based on course descriptions data from employer information system(s) 122.

End-user client device(s) 106 may access marketplace system 110 to search and view course offerings through an end-user portal based on the courses data from system infrastructure coupler 114 and/or institution client device(s) 102. Marketplace system 110 may provide information on which employers are hiring out of certain courses and which employers helped design certain courses. The end-user client device(s) 106 may also access marketplace system 110 to retrieve profiles of various employers corresponding to the employer client device(s) 104 and see which courses the employers are hiring out of. Additionally, the end-user client device(s) 106 may use the end-user portal to create a course-specific user career pathway. For example, diagrams and data representations may be generated that illustrate, for a single course, the many credentials, degrees, or career/job opportunities that one course could lead to. End-user client device(s) 106 may use the end-user portal to register and enroll in courses through the marketplace system 110. The end-user portal may provide end-user client device(s) 106 with a list of courses that a particular user is enrolled in and launch the courses (e.g., an online learning component) from a web browser or client application. Student-specific data, such as student ID, course progress and course completion data are also transmitted from the institutional information system(s) 116 to the marketplace system 110, to populate private student records inside the end-user portal of the marketplace system 110.

Payment system 120 may comprise servers or processing devices for processing payment from institution client device(s) 102 (such as sales commission for enrollment), employer client device(s) 104 (such as recruiter fees for hiring from courses, or a periodic subscription plan for access), and end-user client device(s) 106 (such as enrollment and course fees). Administrative client device(s) 112 may login to marketplace system 110 to access a portal for managing and configuring functionalities of the institution portal, the employer portal, and the end-user portal.

Network 108 may be any suitable type of network allowing transport of data communications across thereof. The network 108 may couple devices so that communications may be exchanged, such as between servers and client devices or other types of devices, including between wireless devices coupled via a wireless network, for example. Network 108 may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices may be encrypted using, for example, the Advanced Encryption Standard (AES) with a 128, 192, or 256-bit key size, or any other encryption standard known in the art.

Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like. In an example embodiment, a server may include or have access to memory for storing instructions or applications for the performance of various functions and a corresponding processor for executing stored instructions or applications. For example, the memory may store an instance of the server configured to operate in accordance with the disclosed embodiments.

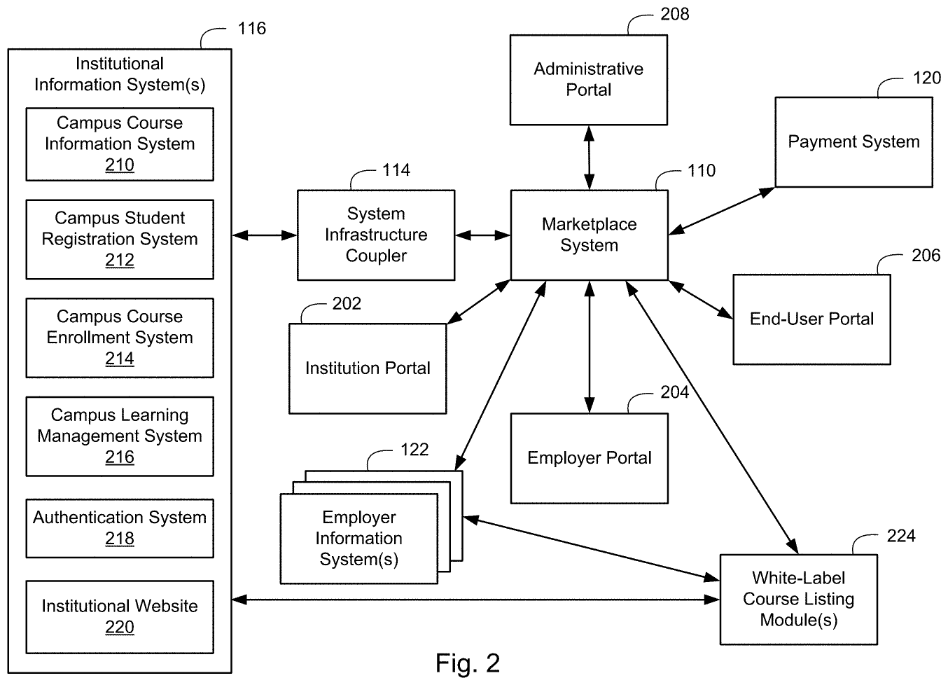

FIG. 2 presents another computing system according to an embodiment of the present invention. Institution portal 202, employer portal 204, end-user portal 206, and administrative portal 208 may comprise a web interface or client executing on a client device, such as institution client device(s) 102, employer client device(s) 104, end-user client device(s) 106, and administrative client device(s) 112, respectively. Administrative portal 208 may generally provide features and functionalities to administrative client devices for managing the operation and features of institution portal 202, employer portal 204, and end-user portal 206. The administrative portal 208 may include dashboard analytics, end-user management, course management, blog management, promotional codes, and messaging with institutions, employers, and end-users.

Institution portal 202 may generally provide features and functionalities including educational institution analytics, student management, course management, blog management, educational institution forum, promotional codes, student enquiry messages, internal chat, and manage educational institution administration. Users of institution portal 202 may include course instructors, deans, course administrators, or other staff from educational institutions. Institution portal 202 may support employer-to-institution requests where a list of email addresses, social networking profile links, or any other form of contact information may be provided to institution portal 202 for forwarding of the employer-to-institution requests of one or more categories/subcategories of request. Institution portal 202 may also be used to enter information about employers who have hired out of classes (e.g., instructors who maintain contact with students after graduation and know which jobs they ended up in, or who talk regularly to employers hiring out of their class about who they've hired). An educational institution forum may be accessed from the institution portal 202 where educational institution users may post questions and discussions to other educational institution users, e.g., of marketplace system 110.

The institution portal 202 may allow the institution client device to add and publish course offerings to marketplace system 110. Course offerings added and published to marketplace system 110 may be based on course descriptions data from campus course information system 210. Data for adding and publishing course offerings on marketplace system 110 can be synchronized with campus course information system 210 through system infrastructure coupler 114. For example, adding and publishing course offerings may include the marketplace system 110 receiving course data from the institution portal 202 in combination with retrieving course data from the institutional information system(s) 116 via system infrastructure coupler 114.

Marketplace system 110 can publish the course data on a website or client application that is accessible through end-user portal 206. The course data may include course title/name, course description, course ID, enrollments remaining/allowed, course status, course instructor, course/instructor email, course credits, course start-end dates, course type (online, in-person, hybrid), enrollment deadline, course eligibility, related occupations, related credentials or degrees, related courses, and employer hiring from the course. Access to certain system components and data of institutional information system(s) 116 may be provided to end-user portal 206 by user-level authentication with authentication system 218. For example, if end-user portal 206 wishes to access course material stored in campus learning management system 216, or enroll in a course whose enrollment is managed by campus course enrollment system 214, the request may go through authentication system 218, prior to being routed internally to campus course enrollment system 214 or campus learning management system 216. The institution portal 202 may further include functionality for generating, issuing, and managing coupon codes in addition to requesting them from educational institutions. Coupon codes may comprise discounts or promotional offers associated with course offerings published on the marketplace system 110. The coupon codes may be applied upon checkout and payment for courses on marketplace system 110.

Institution-specific course offerings from marketplace system 110 may also be provided on an institutional website 220. White-label course listing module(s) 224 may filter course data from marketplace system 110 for course offerings from a specific educational institution and then export the filtered course data to custom-branded white-label webpages integrated with the institutional website 220 corresponding to the given educational institution. The custom-branded white-label webpages may be branded to blend in with content on the institutional website 220 but communicatively coupled and managed by marketplace system 110. That is, interactions with and functionality of the custom-branded white-label webpages, such as course offering selection and purchase, may be controlled by marketplace system 110.

Institution portal 202 may be used to assign levels of knowledge, skills, ability, and experience to a course or end-user. Institution administrators or instructors entering course data on institution portal 202 may be given a list of the knowledge, skills, and experience (“KSE”) types mapped against the U.S. Department of Labor O*NET taxonomy. From there, they may be asked to give a numerical level to each KSE. To help the institution users do so accurately, they may be provided with descriptions of an anchor corresponding to each level. For example, Persuasion, Level 2=“Solicit donations for a charity,” Persuasion, Level 4=“Convince a supervisor to purchase a new copy machine,” Persuasion, Level 6=“Change the opinion of a jury in a complex legal case.” An student/end-user's record can be imbued with each course's KSE levels upon course completion. Furthermore, employers have the ability to filter a list of job applicants by KSE and their levels.

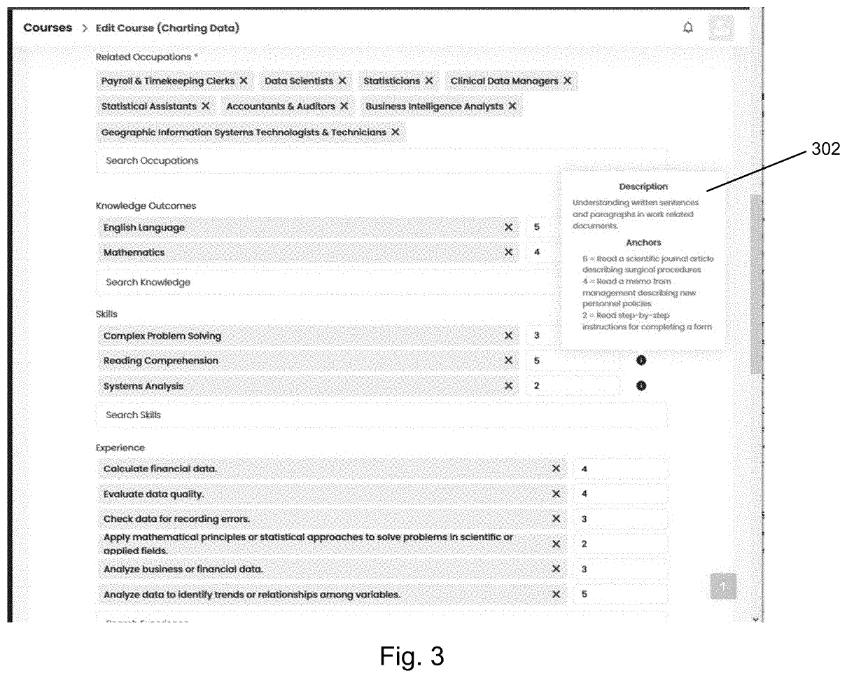

Referring to FIG. 3, expertise levels are assigned to tags corresponding to each KSE a course offers, using a scale guided by, for example O*NET anchors. Popup 302 for each KSE describes the scale for that item. The addition of numeric levels to skill tags may allow the distinction between, for example, the “writing” skill of a student graduating from 3^{rd} grade English vs. the “writing” skill of a student graduating from collegiate English. As such, a common framework may be provided for employers and institutions to communicate level of skill or experience.

When users of end-user portal 206 purchase courses, marketplace system 110 may automatically send the institution (institutional information system(s) 116) a notification that it has a new student. The notification may be sent either through a notifications page of institution portal 202 or through email to institution representatives. The notification or email may contain at least a course ID, a full name of the student, and contact information for the student. Using this contact information, the institutional information system(s) 116 may transmit to the student information s/he needs to access the course (e.g., authentication) via the end-user portal 206, and for in-person courses, information of when and where to be present. Communications may be conducted through marketplace system 110, via an institution-learner chat function, or via phone or email. The marketplace system 110 may further facilitate registration and enrollment of courses with users of end-user portal 206 which is automatically entered into the institutional information system(s) 116. That is, the marketplace system 110 can process registration and enrollment data and forward the data to system infrastructure coupler 114 which may then exchange data associated with the registration and enrollment data with campus student registration system 212 and campus course enrollment system 214. Alternatively, the marketplace 110 can display the registration and enrollment data within institution portal 202, and institutional staff may extract this information and enter it into their own systems.

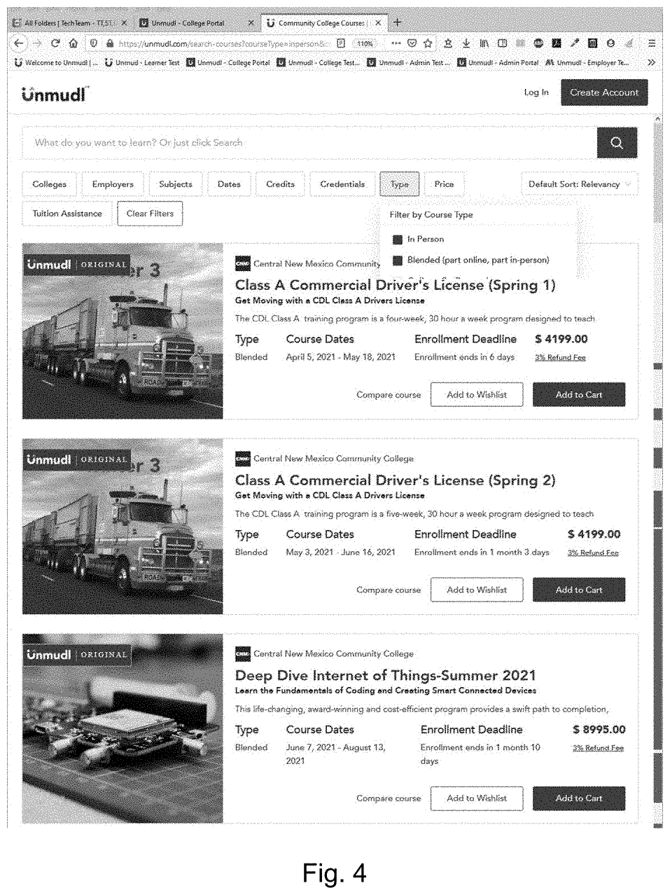

End-user portal 206 may generally provide features and functionalities to end-user client devices that include loading a landing page with featured courses, providing a course search page with advanced filters (e.g., by subjects, employers, occupations, or funding options), adding courses to a cart/wishlist/gift/buy instantly, enabling message/chat with educational institutions, employers, or marketplace system, and account and/or profile administration. As shown by FIG. 4, an end-user client device may access end-user portal 206 to view, search by filter, and purchase in-person and hybrid classes. A listing of courses may be generated for the end-user portal 206 based on published course offering data from marketplace system 110. End-user portal 206 may allow for purchase, registration, and enrollment of any classes offered by marketplace system 110 subject to availability. Registration and enrollment may include marketplace system 110 forwarding information to campus student registration system 212 and campus course enrollment system 214 from an end-user account, such as full name, email address, phone number, etc.

End-user portal 206 may further communicate with marketplace system 110 to generate user career pathways for specific courses including diagrams and data representations that illustrate, for example, for each potential end goal, a list or depiction of other steps, beyond a given course, needed to get to each goal. The end-user portal 206 may also generate personalized futures based on information received from an end-user client device (e.g., data entry, imported from institutional information system(s) 116, or imported from a profile stored on marketplace system 110) into a diagram to identify steps they have completed along each potential path. The diagram may be adapted to show closer completion to affected goals such that an end-user can easily see the many potential educational or career futures he is buying when considering buying a given course. Specifically, the end-user portal 206 may allow steps that may already been completed (e.g., successfully passed courses or pre-requisite certifications) to be added to the diagram via data entry, backend communication with institutional information system(s) 116, or by importing data from an end-user's record of completions stored within a profile at marketplace system 110. Both noncredit and for-credit courses can appear as steps towards the same calculated end goal.

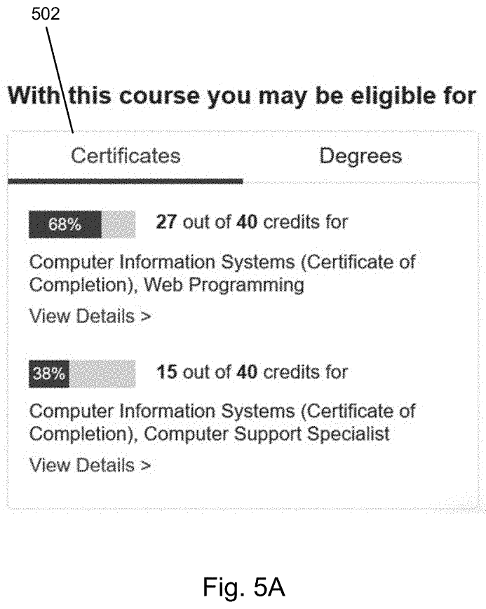

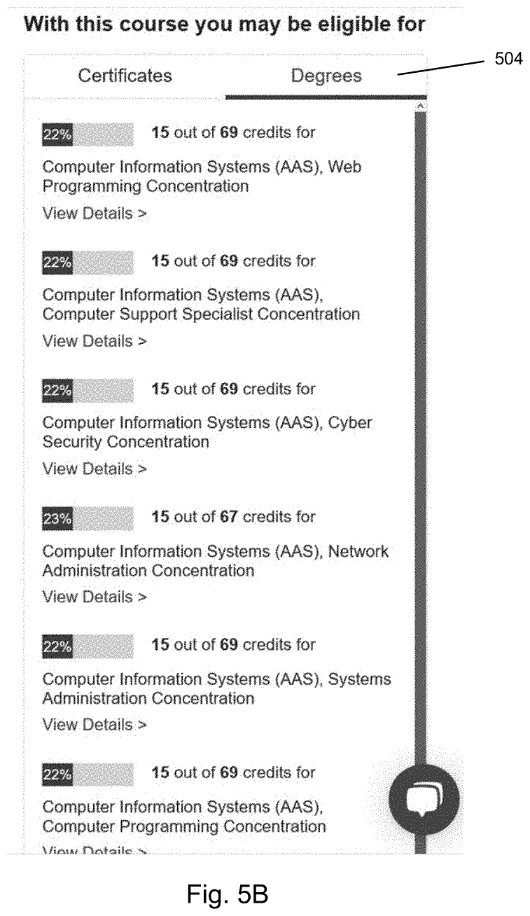

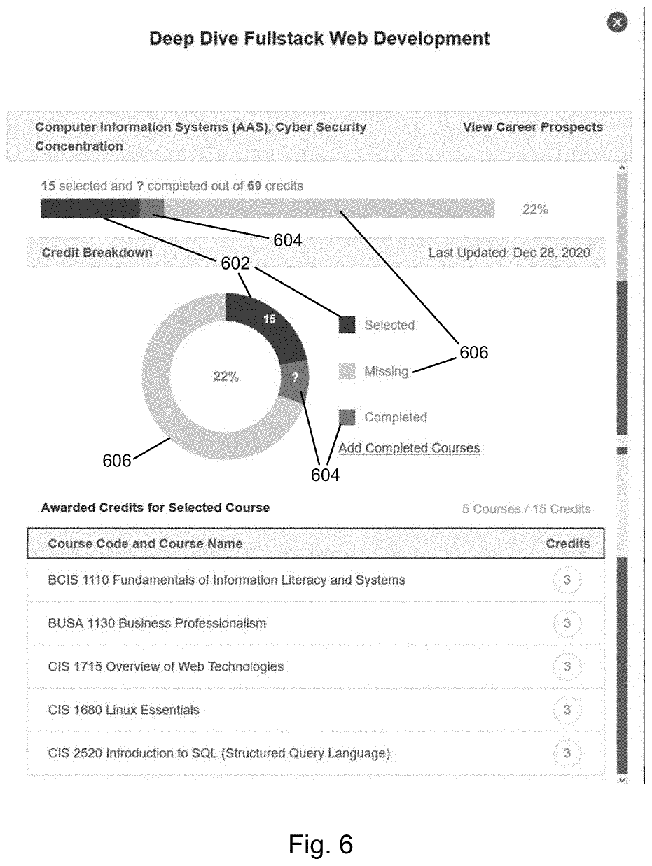

FIGS. 5A and 5B present exemplary pathway depictions for a “Deep Dive Fullstack Web Development” course offering. FIG. 5A depicts a noncredit course can lead to two certificate pathways 502 and FIG. 5B depicts the same noncredit course can also lead to six different degree pathways 504 at an institution. As shown in FIG. 6, a detailed view of a given pathway may be selected and displayed on the end-user portal 206 including a personalized user journey needed to complete the pathway. In the illustrated example, “selected” 602 represents what buying (and completing) the selected one noncredit course would get the end-user; “completed” 604 represents what the end-user already has accomplished (e.g., courses already taken), and “missing” 606 represents the steps remaining to the goal. Traditional career guidance systems start by having a user establish a desired end goal, such as a bachelor's degree in archaeology, or a career as a physician, and then list the steps needed to achieve that goal (i.e., one endpoint achieved by many steps). By contrast, the presently disclosed system may need just a single course a user is considering purchasing to generate a plurality of endpoints that single course could lead to.

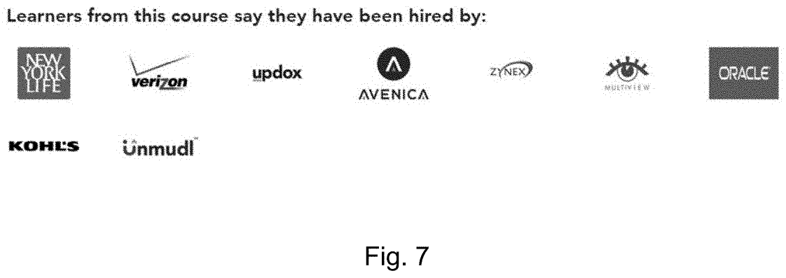

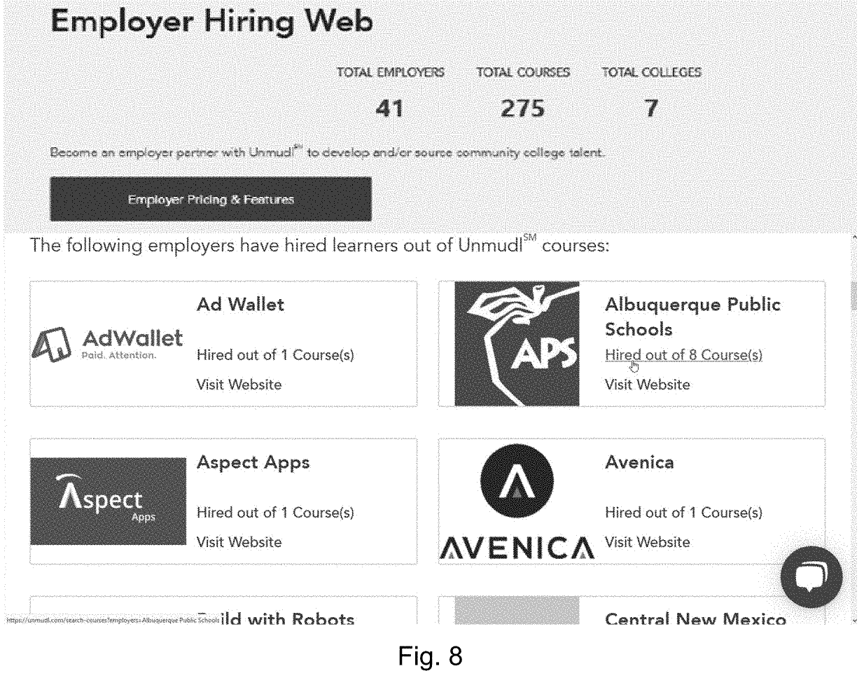

Course listings generated for the end-user portal 206 may further include information on which employers are hiring/hired out of specific courses. For example, a given course listing may include logos of specific companies under “Learners from this course say they have been hired by . . . ,” as illustrated in FIG. 7. Referring to FIG. 8, end-user portal 206 may allow an end-user to determine a potential economic benefit at the level of a single course by clicking on any employer to view the courses that the employer is hiring/hired out of.

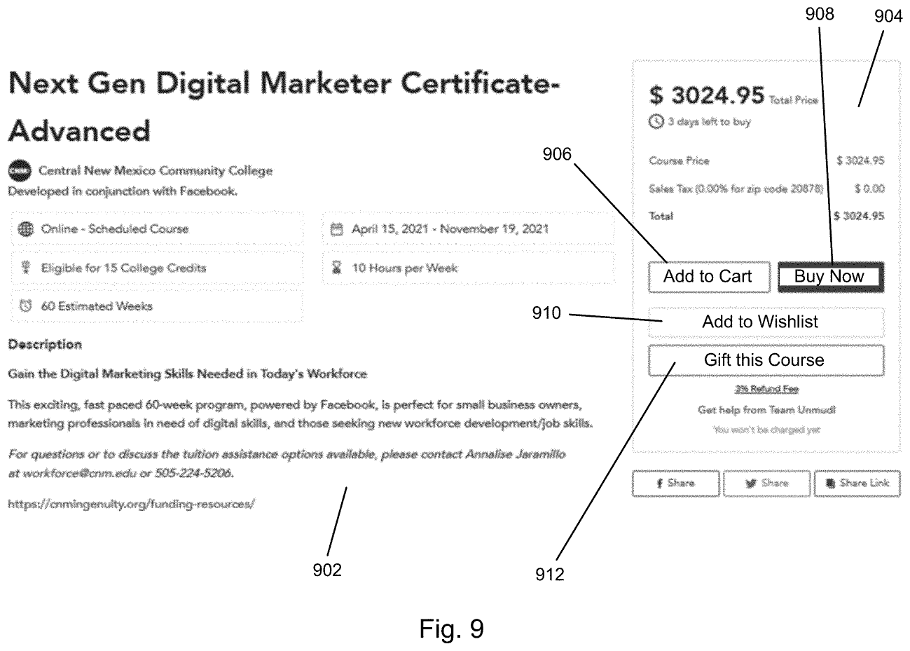

FIG. 9 presents an exemplary checkout interface according to an embodiment of the present invention. An end-user may be presented with a checkout interface upon selecting a course offering for purchase on the end-user portal 206. The checkout interface includes course details 902 and purchasing details 904. The end-user may select “Add to Cart” 906 to add the course to a virtual shopping cart or select “Buy Now” 908 to immediately purchase the course at checkout. Alternatively, the end-user may select “Add to Wishlist” 910 to add the course to a virtual wish list that may be saved for a future purchase or shared with other users to indicate that the course offering is desired by the end-user.

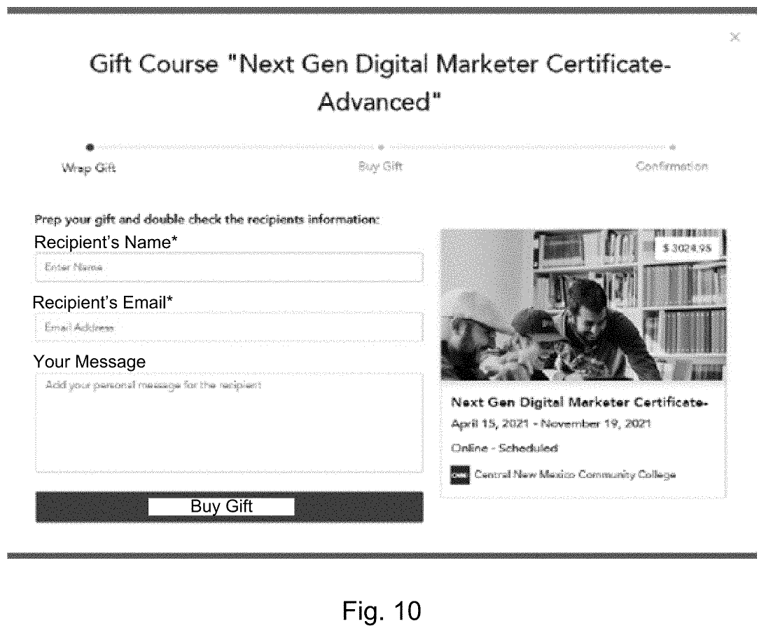

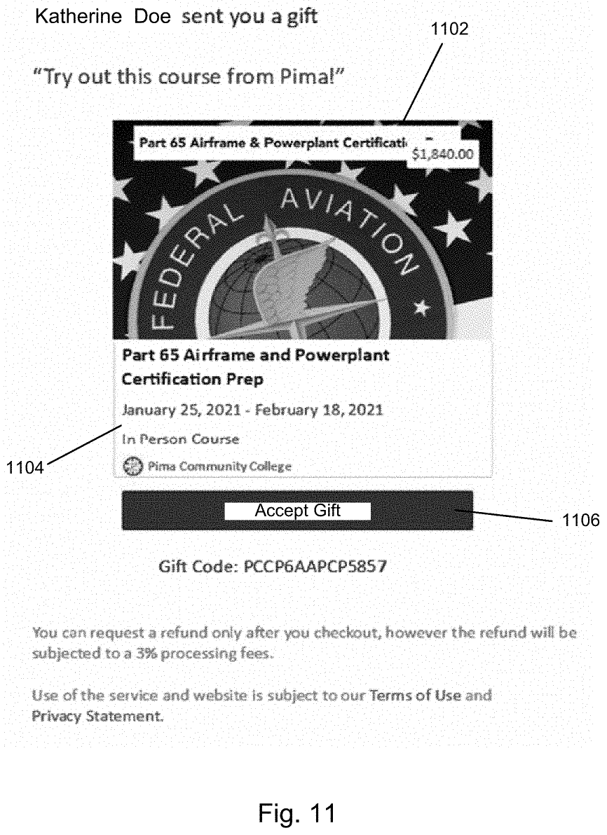

The course offering may also be gifted to a recipient by selecting “Gift this Course” 912 which causes a pop up window interface (FIG. 10) to display for entering, for example, a recipient's name, email address, and a personalized message. Using the pop up window, the end-user may request a gift message to be generated by the marketplace system 110 and sent to the recipient's email address using the entered recipient's name, email address, and personalized message. FIG. 11 presents an exemplary course gift message according to an embodiment of the present invention. The gift message may include a course picture 1102, course details 1104, and an “Accept Gift” link 1106. Clicking the “Accept Gift” link 1106 may cause the marketplace system 110 to charge the end-user, and generate a notification to the end-user that the gift was accepted. At the same time, the gift recipient may be taken through an information gathering and enrollment process with the marketplace system 110 and/or an educational institution associated with the gifted course offering.

Referring back to FIG. 2, end-user portal 206 may further allow an end-user to view their course enrollments, access course content (e.g., lecture videos, conference links/information, documents, exams, etc.), and view their course progress. Content accessed through the end-user portal 206 may be viewed in one or more rendering types. For example, course content may be viewed and interacted in a virtual reality or augmented reality mode in addition to content that may be consumed by text, video, audio, etc. The virtual reality or augmented reality mode may be useful for courses that rely on hands-on training by simulating physical training.

According to one embodiment, end-user portal 206 may deliver course content by accessing campus learning management system 216 through system infrastructure coupler 114. For example, a user of end-user portal 206 may be authenticated (e.g., single sign on) with authentication system 218 through system infrastructure coupler 114 and directly connected to, without additional wait or login, to a course as it resides on campus learning management system 216. Progress that is made in a course hosted inside campus learning management system 216 may be tracked in the end-user's account on end-user portal 206. End-user portal 206 may be used to access a plurality of LMS, enrollment systems, and course information systems, etc., across multiple educational institutions at the same time, with each specific institutional information system(s) 116 set of data access firewalled from each other.

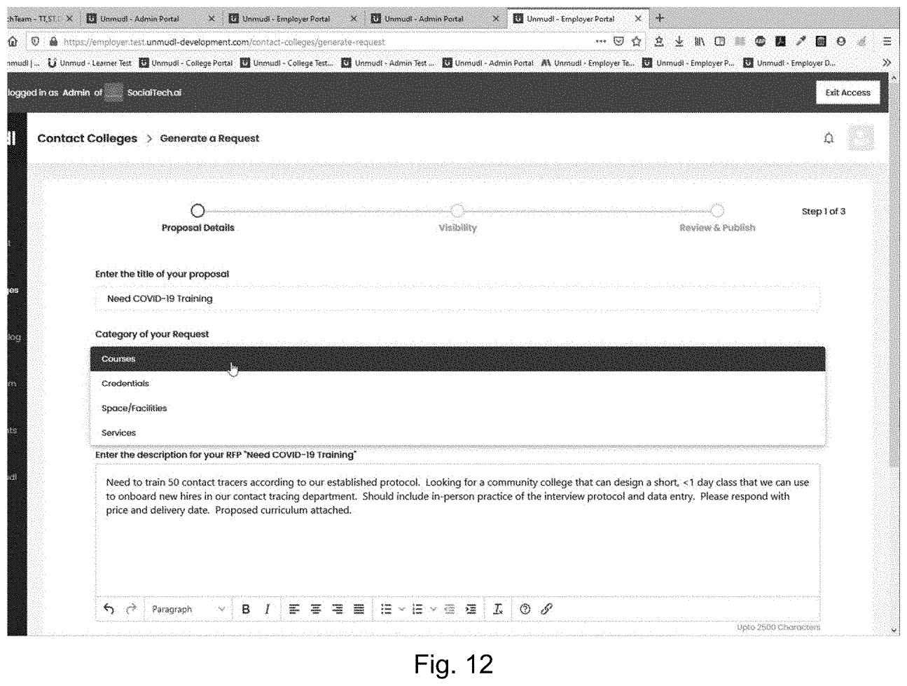

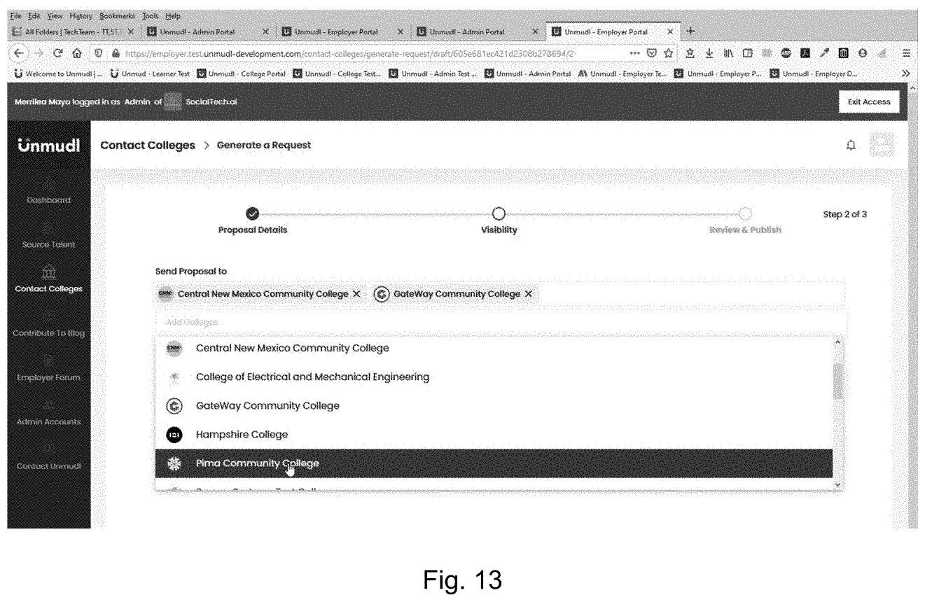

Employer portal 204 may generally provide features and functionalities to employer client devices that include employer analytics, educational institution services requests, source talent requests to educational institution and end-users/students, blog management, subscription plan management, employer forum, marketplace system contact, and employer administration management. Educational institution services requests may comprise employer-to-institution requests to any or all educational institutions associated with institutional information system(s) 116. Employer-to-institution requests may include requests from employer client devices to reserve a campus facility or meeting space, reserve equipment time, request a speaker, request a consultant, request an employee, commission a new course, request a custom course (e.g., request for proposal), request a coupon/gift codes for a course, coordinate tuition reimbursement programs, identify top students in a course, inquire about a credential, collaborate on a physical event, host a job fair or other career service, collaborate on an initiative, coordinate an internship/externship program, and conduct new employee skills assessments. The employer portal 204 may further include functionality for generating, issuing, and managing coupon codes similar to institution portal 202, as discussed above. The employer portal 204 may allow an employer user to select a category and subcategory of request (FIG. 12), write a brief description, and send a request to any or all educational institutions (FIG. 13) on employer portal 204.

When employers send requests to educational institutions, they may identify the educational institutions by name from a list, by affinity group (e.g., all Hispanic-serving institutions) or by geographic region provided by employer portal 204. The request may then be routed to the identified educational institutions using email/contact lists the educational institutions have previously provided. The requests may be forwarded to specific email addresses corresponding to category and subcategory of the requests as specified by the educational institutions. If specific email addresses are not specified for a category and subcategory of a request, the request may default to being sent to the educational institution's super administrator email. Educational institution personnel may receive a notification of an employer request on their account in institution portal 202 and also via externally sent email. Once any person on the educational institution team responds inside their account, a chat page dialogue format, with attachment capabilities, may capture the conversation and everyone who is on either the educational institution or the employer team distribution list can see the dialogue. Conversely, educational institutions may also message employers for requests that are routed to appropriate individuals associated with the employers.

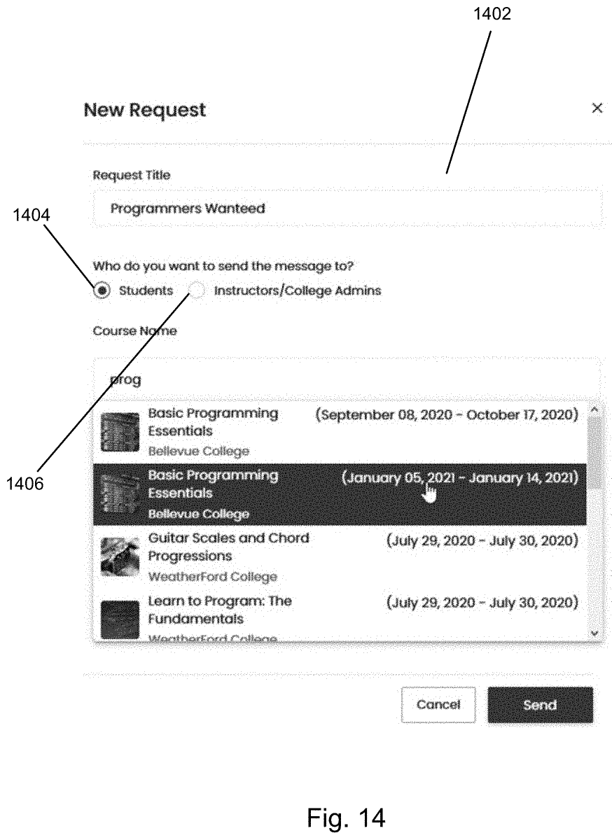

FIG. 14 presents an exemplary interface for course-level messaging according to an embodiment of the present invention. Employers may send requests to either a course's students or its instructor by selecting a class and inputting a message via the employer portal 204. An employer can click on a class, a dialogue box 1402 opens, and the employer can instantly message all current and former students 1404 of that class, for example, with job announcements. Similarly, an employer can instantly message the instructors 1406 of that class from the dialogue box 1402. For example, an employer may ask an instructor who are the top people in his class who might be good fits for his company. The messages may be routed to email addresses of the respective message recipients that are associated with a course ID corresponding to the class. Alternatively, other forms of communications may also be used, such as via phone, through social networking sites, or any other forms of electronic communications.

By messaging students in a class who are learning or have learned a specific skill, employers cut down on spurious applications to a given job opening. Using this feature, employers are ensured that each person who responds to the request or announcement, has had, or is in the process of obtaining, the desired skill set. The ability to message course instructors allows employers to obtain specific information about potential best hires that they could not easily obtain from resumes, for example. Messaging or request activity (including number or frequency of messages sent to a particular course) from employers through this feature may be collected by the marketplace system 110 from the employer portal 204 and used for publishing with course offerings on the end-user portal 206 to indicate employer interest in specific courses. Marketplace system 110 may also survey employers directly about which courses they have hired out of, and add that information to the courses. Data collected regarding employer interest in particular courses may be provided as data that may be viewed in a dashboard on employer portal 204 as well as institution portal 202 and end-user portal 206. Additionally, the data may be separately marketed as API feeds. Such data may be representative of a type of labor market signal of interest to colleges, employers, and end users alike.

Referring back to FIG. 2, the employer portal 204 may also allow employer client devices to add and publish course offerings to marketplace system 110 similar to institution portal 202. Courses added and published to marketplace system 110 may be based on course descriptions data from employer information system(s) 122. Data for adding and publishing courses on marketplace system 110 can be synchronized with the employer information system(s) 122. For example, adding and publishing courses may include the marketplace system 110 receiving course data from the employer portal 204 in combination with retrieving course data from the employer information system(s) 122. Marketplace system 110 can publish the course data on a website or client application that is accessible through end-user portal 206.

Employer information system(s) 122 may further include a learning management system that may export employer-specific training content to the marketplace system 110, at which point it will be redirected to the end-user portal 206. The employer information system(s) 122 may also include an employer website to which the white-label course listing module(s) 224 can publish course data. White-label course listing module(s) 224 may filter course data from marketplace system 110 for employer-specific course offerings and then export them to custom-branded white-label web pages integrated with a website of the specific employer. The custom-branded white-label web pages may be branded to blend in with content on the employer website but communicatively coupled and managed by marketplace system 110.

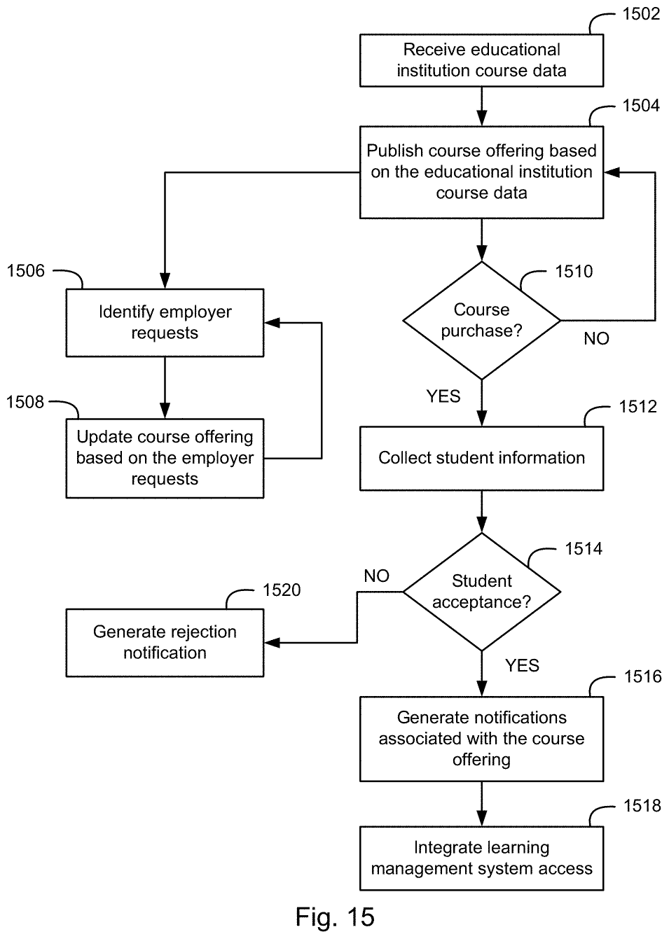

FIG. 15 presents a flowchart of a method for connecting technological infrastructure of educational institutions with an external web-based platform according to an embodiment of the present invention. A web-based platform comprising one or more servers or cloud computing instances is configured for managing (including the sale and enrollment of) in-person, online, or hybrid (e.g., in-person and online) learning courses that are offered by a plurality of educational institutions. The web-based platform receives educational institution course data in response to a request from an institution client device to publish a course on the web-based platform, step 1502. The educational institution course data may include course title/name, course description, course ID, enrollments remaining/allowed, course status, course instructor, course/instructor name and email, course credits, course start-end dates, course times, course locations, course type (online, in-person, hybrid), enrollment deadline, course eligibility (enrollment restrictions), related occupations, subject area, course learning outcomes, course knowledge list, course skills list, list of practical experiences obtained during the course, related credentials or degrees, related courses, and employer hiring from the course. The educational institution course data may be received from a campus course information system through a system infrastructure coupler. The system infrastructure coupler may comprise an application or cloud computing/virtualized instance that provides integration of data (e.g., educational institution course data, enrollment, and registration) from a plurality of educational institutions via institutional information systems with the web-based platform. Data connections and access to each of the educational institution's information systems may be firewalled from each other by the system infrastructure coupler.

A course offering is published based on the educational institution course data, step 1504. The web-based platform may publish the course offering on a website or client application that is accessible through an end-user portal. End-users may view details of the published course offering and submit a purchase of the course offering from an end-user account on an end-user portal. If the web-based platform determines that a purchase of the course offering was made, step 1510, it may proceed to collect student information, step 1512. Collecting the student information may include retrieving data from an end-user account and/or soliciting, with the purchase or receipt of the course as a gift, information, such as full name, qualifications, home or mailing address, phone number, student ID, date of birth, and email.

The educational institution corresponding to the course offering is queried of an acceptance of an end-user as a new student, step 1514. Querying the educational institution may include forwarding the collected student information to the educational institution for registration and enrollment. The educational institution decides whether to accept the student or not. A given course can be configured by the educational institution such that anyone who purchases it is automatically accepted. Alternatively, the educational institution may assign their backend systems the task of determining whether to accept a student. Another alternative may include an administrator accepting or declining the student via an institution portal.

If the student is not accepted, a rejection notification is generated, step 1520. If the student is accepted, notifications associated with the course offering is generated, step 1516. A first notification may be sent either through a notifications page of the institution portal, to an institutional information system, or through email to institution representatives. The notification or email may contain at least a course ID, a full name of a student, and contact information for the student. The web-based platform may further forward registration and enrollment data to the institutional information system via the system infrastructure coupler or to the institution portal. A second notification may be sent to the student through a notifications page of the end-user portal or by external email, letting them know they were accepted, and giving them the next steps on how to connect to the course (e.g., push a “launch course” button on an image of a course on the end-user portal (learning management system integrated), or whether instructions to show up in person at a specific time and place (in-person course), or whether to log into an institution-operated system).

Learning management system access is also integrated with the web-based platform, step 1518. Access to an educational institution's LMS is arranged with the web-based platform for the purchase such that the student may access course content corresponding to the purchase of the course offering from an end-user portal. The LMS may include course content that the student may access. The student may access the LMS from a direct link on the end-user portal which automatically authenticates the student with the institutional information system. Course content may be downloaded or streamed from the LMS, such as lecture videos, conference links/information, documents, exams, etc., may be accessed from the LMS. The end-user portal may allow the student to access a plurality of LMS and educational institutions at the same time, with each specific institutional information system set of data access firewalled from each other. Progress that is made in a course via LMS may be tracked in an account of the student on the end-user portal.

In a process parallel to step 1510, the web-based platform identifies employer requests in association with a course corresponding to the published course offering, step 1506. Employers may send requests or messages to either a course's students or its instructor. Requests or messaging activity by employers that are associated with the published course may be collected by the web-based platform and used for publishing of the course offering to indicate employer interest in the course offering. For example, the course offering may indicate that certain employers have hired from or are hiring from a course associated with the course offering. The web-based platform may also survey employers directly about which courses they have hired out of, and add that information to the course offering. The course offering is updated based on the employer requests, step 1508. Updating the course offering may include indicating in the course offering that employers associated with the employer requests are interested in students who take a course corresponding to the course offering. The parallel process may return to step 1506 to continue monitoring for employer requests associated with the published course offering.

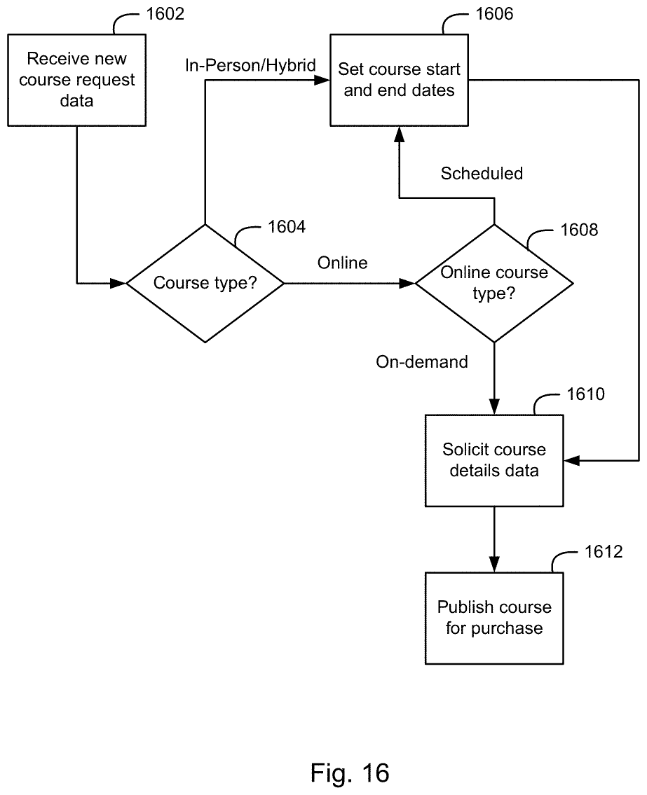

FIG. 16 presents a flowchart of a method for publishing courses according to an embodiment of the present invention. Request data of a new course is received from an institution client device by a web-based server, step 1602. The request data may include course name, type, description, subject, course dates, enrollment deadline, etc. A course type is determined by the web-based server, step 1604. If the course type is in-person or hybrid, course start and end dates are set, step 1606 and proceeds to solicit course details data, step 1610. If the course type is online, an online course type of the new course is determined, step 1608. A determination of a scheduled type online course causes the web-based server to set course start and end dates, step 1606, and then solicit course details data from the institution client device, step 1610.

A determination of an on-demand type online course causes the web-based server to solicit course details data, step 1610. Course details data that are solicited at step 1610 may include course occupation, level-matched skills, level-matched knowledge, level-matched experiences, employers hiring from the new course. An external ID (for access via a system infrastructure coupler) may also be provided to connect with institutional information systems for the new course. The web-based server publishes the new course for purchase based on the course details, step 1612.

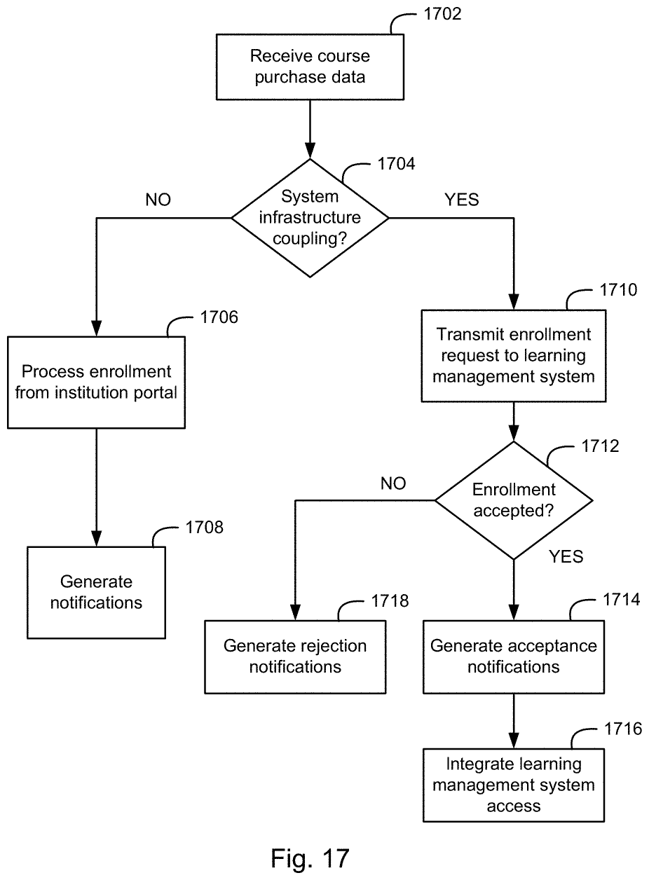

FIG. 17 presents a flowchart of a method for processing course enrollment according to an embodiment of the present invention. Course purchase data from an end-user client device is received by a web-based server, step 1702. The course purchase data may include course selection(s) and payment information and/or confirmation. The web-based server determines whether a system infrastructure coupling has been established and is available, step 1704. A system infrastructure coupling may allow for the web-based server to facilitate data communications with institutional information systems corresponding to the course purchase data.

If a system infrastructure coupling is not available, enrollment into a course associated with the course purchase data is processed via institution portal, step 1706. Notifications are generated based on the processing of the enrollment, step 1708. The notifications may include enrollment notifications for the institutions as well as for an enrolled student. The notifications may include an indication of enrollment acceptance or rejection, and details on when and where to be present (for in-person learning) or course material information. On the other hand, if a system infrastructure coupling is available, an enrollment request is transmitted to a learning management system, step 1710. The learning management system may process an enrollment into a course associated with the course purchase data.

The web-based server determines whether enrollment has been accepted by the learning management system, step 1712. If not, the web-based server generates rejection notifications based on the processing of the enrollment (e.g., not accepted) by the learning management system, step 1718. The notifications may be transmitted to both the end-user portal and the institution portal or electronically communicated, such as email. If the enrollment has been accepted by the learning management system, acceptance notifications are generated also to both the end-user portal and the institution portal or electronically communicated, such as email, step 1714. Learning management system access is integrated with the web-based server, step 1716. The integration may include configuring an end-user portal where the end-user client device can access downloadable or streamable content associated with enrolled courses from the learning management system.

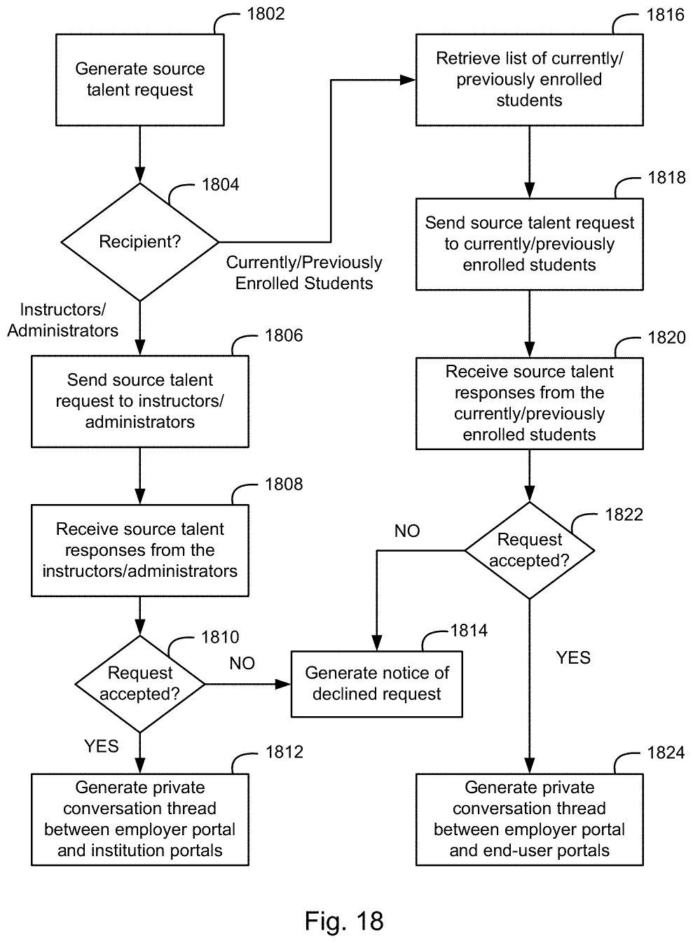

FIG. 18 presents a flowchart of a method for facilitating source talent requests according to an embodiment of the present invention. An employer portal may include functionality for sourcing talent through a web-based server. A source talent request is generated by the web-based server, step 1802. The source talent request may be initiated via the employer portal where details, such as a title, message details, a particular course (e.g., or a common course offered by a plurality of institutions), and a target recipient may be specified. The web-based server determines the target recipient(s) to send the source talent request based on the source talent request, step 1804. At step 1806, the source talent request is sent to instructors or administrators of the particular course. Sending the source talent request may include generating messages or notifications that may be accepted or declined via an institution portal or electronic communication message, such as email.

One or more source talent responses are received from the instructors or administrators, step 1808. The web-based server determines whether source talent requests are accepted based on the source talent responses, step 1810. If a source talent request is accepted, a private conversation thread between the employer portal and an institution portal associated with an instructor or administrator who accepted the source talent request is generated, step 1812. The web-based server also determines instructors or administers who declined or not responded to the source talent request which causes the web-based server to generate notices of declined requests to the employer portal, step 1814.

If a source talent request is sent to currently or previously enrolled students, a list of students that are currently or previously enrolled in the particular course of the source talent request is retrieved, step 1816. The source talent request is sent to the currently or previously enrolled students on the list of students, step 1818. Sending the source talent request may include generating messages or notifications that may be accepted or declined via an end-user portal or electronic communication message, such as email. One or more source talent responses are received from the currently or previously enrolled students, step 1820. The web-based server determines whether source talent requests are accepted based on the source talent responses, step 1822. If a source talent request is accepted, a private conversation thread between the employer portal and an end-user portal associated with a currently or previously enrolled student who accepted the source talent request is generated, step 1824. The web-based server also determines currently or previously enrolled students who declined or not responded to the source talent request which causes the web-based server to generate notices of declined requests to the employer portal, step 1814.

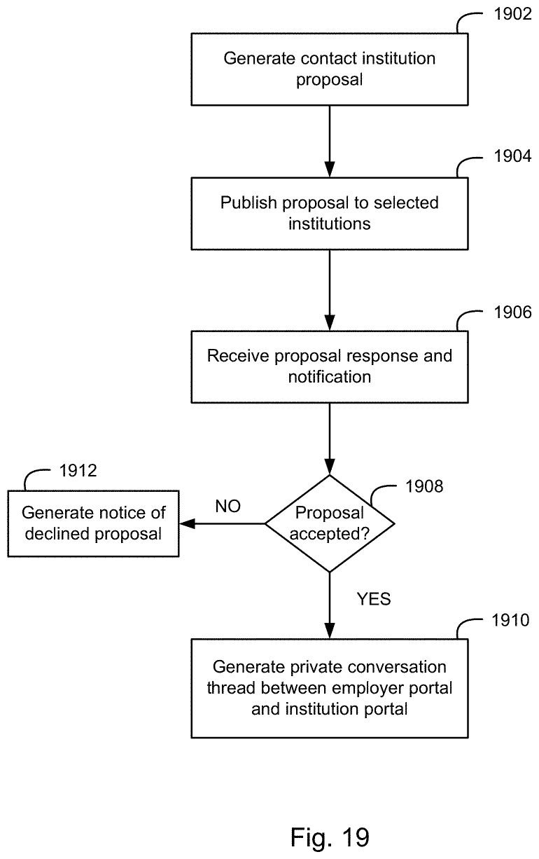

FIG. 19 illustrates a flowchart of a method for facilitating employer to institution services requests according to an embodiment of the present invention. An employer portal may include functionality for requesting institution services through a web-based server. A contact institution proposal is generated by the web-based server, step 1902. The contact institution proposal may be initiated via the employer portal where details, such as proposal title and details may be submitted. The contact institution proposal may be configured for selective access (e.g., given employer members can access the proposal). Additionally, proposal documents may be uploaded and attached to the contact institution proposal though the employer portal. A category and subcategory of proposal may be selected for the contact institution proposal. One or more institutions may be selected to send the contact institution proposal to. A set of educational institutions may be selected at one time via affinity or geographic groupings.

The contact institution proposal is published to the selected institutions, step 1904. The selected institutions may receive and respond to the contact institution proposal by providing response message details, attaching response documents and submitting the proposal response via an institution portal. The proposal response may also be configured for selective access (e.g., given institution members can access the proposal response). One or more proposal responses and notifications are received from the selected institutions, step 1906. The web-based server determines whether the contact institution proposals are accepted based on the proposal responses, step 1908. If a contact institution proposal is accepted, a private conversation thread between the employer portal and an institution portal associated with an institution who accepted the contact institution proposal is generated, step 1910. The web-based server also determines given ones of the selected institutions who declined or not responded to the contact institution proposal which causes the web-based server to generate notices of declined requests to the employer portal, step 1912.

It is noted that the systems and functionalities described with respect to FIGS. 1 through 19 may be provided or licensed as a turnkey solution that is ready to use and can be implemented into current systems and processes.

FIGS. 1 through 19 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system for connecting technological infrastructure of educational institutions with an external web-based platform, the system comprising:
a system infrastructure coupler that integrates data between institutional information systems and a marketplace system, wherein the system infrastructure coupler retrieves course data from the institutional information systems and provides the marketplace system with access the retrieved course data;
the marketplace system comprising a web-based platform managing learning courses associated with the institutional information systems, the marketplace system using the system infrastructure coupler to access the course data associated with the learning courses, generate offerings for the learning courses based on the course data, and process enrollments to the learning courses with the institutional information systems using student information; and
an end-user portal communicatively coupled to the marketplace system, the end-user portal including access to content associated with the learning courses by accessing a learning management system at the institutional information systems via authentication by the system infrastructure coupler or a third party authentication system, wherein the end-user portal is configured to receive the student information from an end-user client device and transmit the student information to the marketplace system.

2. The system of claim 1 further comprising the marketplace system configured to access the course data from the system infrastructure coupler by using a common set of application programming interfaces.

3. The system of claim 1 further comprising the marketplace system configured to access the course data from the system infrastructure coupler by using an automated file upload and download configuration.

4. The system of claim 1 wherein the learning courses include in-person, online, and hybrid learning courses.

5. The system of claim 1 further comprising the system infrastructure coupler configured to firewall individual ones of the institutional information systems.

6. The system of claim 1 further comprising an institution portal communicatively coupled to the marketplace system, the institution portal configured to add and publish the learning courses to the marketplace system.

7. The system of claim 1 further comprising an employer portal communicatively coupled to the marketplace system, the employer portal configured to solicit talent from a pool of users corresponding to the learning courses.

8. The system of claim 1 wherein the requests include at least one of reserving a campus facility or meeting space, reserving equipment time, finding an expert speaker, requesting a speaker, requesting a consultant, requesting an employee, commissioning a new course, requesting a custom course (e.g., request for proposal), requesting a coupon/gift codes for a course, coordinating tuition reimbursement program, identifying top students in a course, inquiring about a credential, collaborating a physical event, hosting a job fair or other career service, collaborating on an initiative, coordinating an internship/externship program, and requesting services including conducting new employee skills assessments, setting up a demonstration or lab.

9. The system of claim 1 further comprising an employer portal communicatively coupled to the marketplace system, the employer portal configured to connect with users that have taken the learning courses.

10. The system of claim 1 wherein the end-user portal is configured to identify employers hiring out of certain ones of the learning courses.

11. The system of claim 1 wherein the end-user portal is configured to retrieve profiles of employers hiring out of certain ones of the learning courses.

12. The system of claim 1 wherein the end-user portal is configured to generate a course-specific user career pathway based on noncredit and for-credit courses.

13. The system of claim 12 wherein the course-specific user career pathway includes potential credentials, degrees, or job opportunities that a given one of the learning courses lead to.

14. The system of claim 1 further comprising an administrative portal including dashboard analytics, end-user management, course management, blog management, promotional codes, and messaging with institutions, employers, and end-users.

15. The system of claim 1 further comprising a white-label course listing module configured to:
filter the course data from the marketplace system for course offerings from a specific educational institution or employer; and
export the filtered course data to custom-branded white-label web pages integrated with a website corresponding to the specific educational institution or employer.

16. A method, in a data processing system comprising a processor and a memory, for connecting technological infrastructure of educational institutions with an external web-based platform, the method comprising:
receiving, by a web-based platform, course data in response to a request from an institution client device to publish a course on the web-based platform;
publishing, by the web-based platform, a course offering based on the course data;
determining, by the web-based platform, purchase of the course offering;
generating, by the web-based platform, a notification to institutional information systems associated with the course offering; and
integrating access to a learning management system associated with the institutional information systems with the web-based platform.

17. The method of claim 16 wherein the access includes downloadable or streamable content from the learning management system.

18. The method of claim 17 wherein the downloadable or streamable content includes lecture videos, conference links/information, documents, and exams.

19. The method of claim 16 further comprising:
identifying employer requests in association with a course corresponding to the course offering; and
indicating in the course offering that employers associated with the employer requests are interested in students who take a course corresponding to the course offering.

20. The method of claim 16 further comprising tracking student progress in a course through the learning management system in an account on the end-user portal.
